(19) United States
(12) Patent Application Publication
(10) Pub. No.: US 2022/0269660 A1
(43) Pub. Date: Aug. 25, 2022

(54) BLOCKCHAIN BASED PROTECTION FROM DATA MANIPULATION HISTORY IN RELATIONAL DATABASES

(71) Applicant: Nathalie Goldstein, San Jose, CA (US)

(72) Inventors: Nathalie Goldstein, San Jose, CA (US); Joachim Niederreiter, Vienna (AT); DeGuang Sea, Maria Lanzendorf (AT); Markus Finster, Vienna (AT)

(21) Appl. No.: 17/184,843

(22) Filed: Feb. 25, 2021

(51) Int. Cl. G06F 16/21; G06F 16/23; H04L 9/32; G06F 16/242; G06F 16/28; H04L 9/06

(52) U.S. Cl. CPC G06F 16/219; G06F 16/2358; H04L 9/3297; G06F 16/2365; G06F 16/2448; G06F 16/284; H04L 9/0643; H04L 2209/38

(57) ABSTRACT

A method of a blockchain audit-proof logging process is provided. The method comprises a computer creating a log for selected tables in a relational database and creating trigger functions for insert, update, and delete operations for the selected tables. The computer uses the trigger functions to calculate a difference between a previous record and a new record. The computer also uses the trigger functions to calculate a cryptographic hash code for the new record and write the previous record to the log. Calculation of the cryptographic hash code for the new record includes a hash code and time stamp associated with the previous record. The log supports proving manipulation of data input, the manipulation occurring during processes of at least one of collecting, storing, and calculating desired results based on the data input.

### CROSS-REFERENCE TO RELATED APPLICATIONS

The present disclosure is related to U.S. provisional application 63/109,380 filed Nov. 4, 2020, the contents of which are incorporated hereinto in their entirety.

### FEDERALLY SPONSORED RESEARCH

None.

### SEQUENCE LISTING

None.

### FIELD OF THE INVENTION

This application relates to logging of changes entered into a database including at least changes entered directly into a database or through a request made via a software application related to the database, through a blockchain-based methodology.

### BACKGROUND

Software applications commonly receive data and instructions via user input, store the data, and generate results based on this data. As underlying algorithms may be complex, an end user may be unable to verify if output generated by an application is based on validly submitted inputs or perhaps on nefariously manipulated inputs. Further, users may have no direct access to database(s) and may access only inputs that are displayed in a user interface, which may have been previously compromised.

The prior art includes various attempts at addressing the problems described above. U.S. Pat. No. 10,320,566 (2019) to Banerjee, et al. is a method of logging events in a blockchain. Changes to the application and the logging of application events are treated separately. The blockchain assures the consistency of primarily the log, and not the consistency of the data-history itself.

U.S. Pat. No. 10,275,739 (2019) to Hanis, et al. focuses upon the idea of “accessing transactions later by interested parties for ledger verification” and is directed to tracking assets and updates on the assets' status. Examples provided by Hanis include a reference to assets such as “reading a tag affixed to an asset” and “updating the asset status”.

U.S. Pat. No. 10,325,079 (2019) to Vukich, et al. describes a version management for network nodes, but focuses on terms and user consent in case terms have changed. Vukich frequently states “user has consented to a current version of terms associated with a program”.

### SUMMARY

The present disclosure provides systems and methods of creating a tamper-evident log of data changes using relational databases and blockchain technology. A logging method is provided herein uses blockchain technology to provide a log of data-history in a relational database for later data manipulation and examination.

A user is provided with an initial hash-code and links to download data history. The user is also provided software which verifies the consistency of the downloaded data history. Accordingly, several advantages result from a blockchain based data logging method in relational databases such as:
Transparency for the end-user

Tamper-proof: as soon as the first hash-code is published, data cannot be manipulated without evidence being left Low system load by avoiding expensive proof-of-work algorithms

### BRIEF DESCRIPTION OF THE FIGURES

FIG. 1 is diagram illustrating an overview of how records in a database table are created, how hash-codes are calculated, and how records of a history table and a record of a main table are cryptographically chained.

FIG. 2 is a diagram illustrating that systems and methods provided herein are independent from applications and database drivers as database triggers are configured to activate independent of access methods of the database.

FIG. 3 is a diagram illustrating a flow between the application and a user in which data and software are provided to the user to facilitate independent proving of integrity of data manipulation history.

### REFERENCE NUMERALS FOR FIGURES

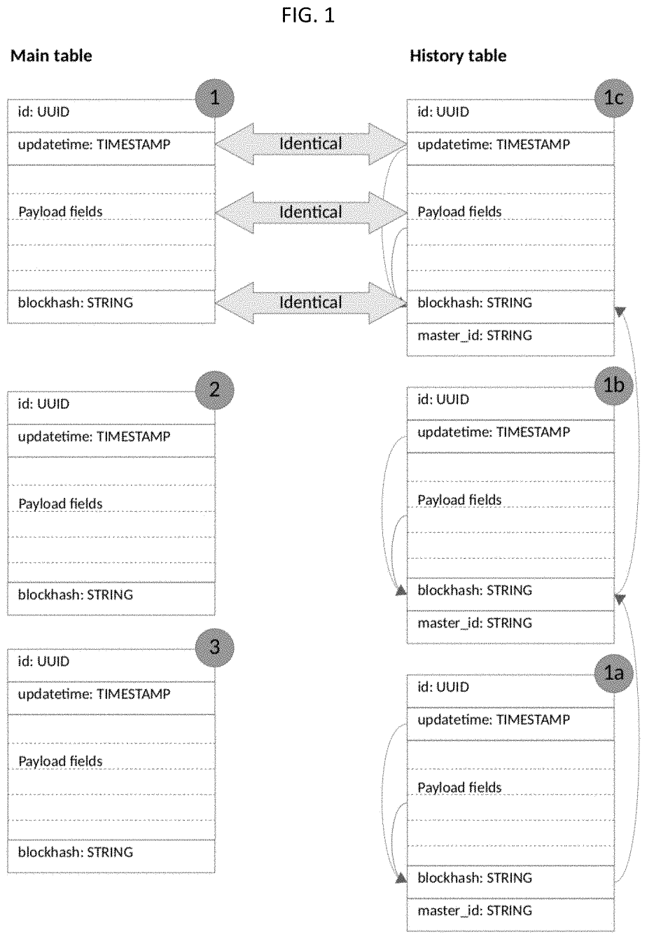

FIG. 1:
(1), (2) and (3) are different (main) records in a database.
(1a), (1b) and (1c) are the data manipulation history of record (1), wherein a payload, an update time, and a block hash of (1)—the current record—may be identical to (1c).
Blockchain and data fields used to calculate hash-codes are visualized via arrows.
Different figures may have the same numbering if an element is the same in both figures.

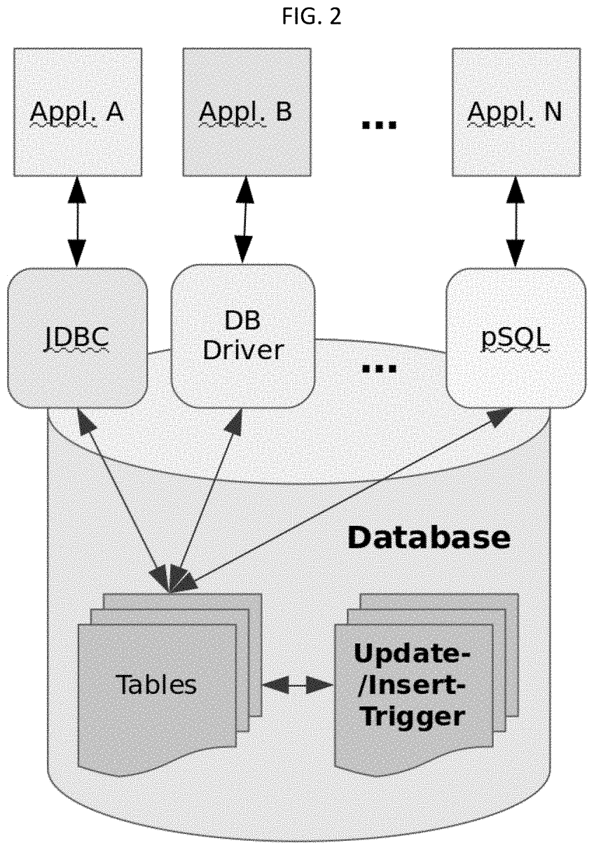

FIG. 2:
FIG. 2 illustrates that the systems and methods provided herein function independently of technology used to access a relational database. Systems and methods are agnostic to applications and work even if the database is accessed directly via SQL-statements.

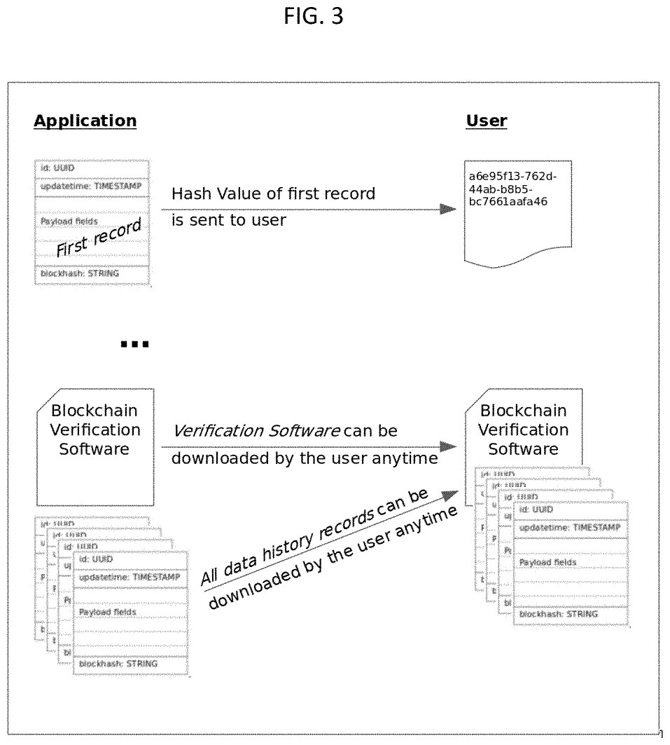

FIG. 3:
FIG. 3 illustrates a structure of the data blocks, corresponding data fields used for blockchain based logging, and how integrity of a blockchain may be verified.

### DETAILED DESCRIPTION

It will be readily understood that the components, as generally described and illustrated in the figures included, may be arranged and designed in different configurations. Therefore, the following detailed description of the embodiments of this method, using a relational database, as represented in the included figures, is not intended to limit the scope of the application as claimed, but is merely representative of selected embodiments.

Using the example as detailed in FIG. 1, this invention uses a computer system consisting of one or more physical computers, a relational database running on that computer system and a software application which uses the relational database as its data storage.

Additionally, downloadable software is provided as source code and as binary executable which allows a user to verify the correctness of the data input history. The software application collects user data in multiple steps, stores the data after each step (e.g., when the user clicks on a “Next” or “Save” button) and calculates results based on the data the user has previously entered.

The relational databases use event triggers to take the following actions after insert steps or update steps:
The currently stored data (“old”) is stored as record in a data-history table.
A cryptographic hash-code is calculated using the current data (“new”), the hash-code of the previous data (“old”) and the timestamp. This cryptographic hash-code is added to the current data (“new”), thus creating a blockchain of the current data record and all the history records.

Using database event triggers may support assurance that each insert or update action triggers the required actions independent of the source of the event. Even if a party tries to change data directly via SQL statements, the event triggers would record those changes in the blockchain-based history table.

An “owner” of database tables needs to be dedicated for data definition manipulation. At least one “database user” of the software application connects to the database and is typically not the owner of database tables. The database tables owner may be a security-critical account similar to “root” account in other systems.

When the initial data input step for a user is executed, for example the user selected an activation link or an initial data record was created in a different manner, the cryptographic hash-code of the initial data record is sent to the user via a preferred communication channel, for example via electronic mail.

The user is additional provided a link which enables downloading of data history records in a human readable format and a link to a downloadable software (as source code and as executable for convenience). The downloadable software takes the downloaded data history as input and verifies correctness of the data history by re-calculating hash-codes. As hash-codes form a blockchain, data manipulation would break the consistency of the hash-code calculation. If the downloadable software executes without an error, the consistency of the data history is validated.

### Operation

In operation, the blockchain audit-proof logging process described herein may be used to continuously create and maintain logs of the data history. These logs can be later used to prove if any data input by was manipulated in the process of collecting, storing and calculating desired results based on this data.
1. Create a log or history table for certain tables in a relational database
2. Create trigger functions for insert, update, or delete of rows for these tables which:
   a. calculate a difference between the old record and the new record;
   b. calculate a cryptographic hash-code for the new record including the old record's hash-code and the timestamp; and
   c. write the old record to the log or history table.
3. Provide a possibility to download the data history in a human readable format at any time
4. Provide software (as source code and as binary executable) that takes the downloaded data history as input and checks consistency of data history by re-calculating the cryptographic hash-codes.

Other previous implementations merit discussion directed to distinctions between these implementations and specific systems and methods provided herein. For example, U.S. Pat. No. 10,075,29 (2018) to Struttmann focuses on preventing attackers to undetectably modify content. It checks the consistency of the blockchain immediately when data is read. Systems and methods provided herein are by contrast targeted to providing proof that data was not modified, thus providing an audit-proof log.

Systems and methods provided herein distinguish between accessing data as part of the application and providing users a downloadable history of data changes as a blockchain. Struttmann excludes timestamp or ordering data. Systems and methods provided herein use timestamps as part of the input to the cryptographic function to calculate the hash code.

Further, U.S. Pat. No. 10,121,019 (2018) by Struttmann provides methods of storing differentials of files in a distributed blockchain. The term “file” is, however, bound to documents as files in an operating system. Struttmann explicitly distinguishes between the document store and the tamper-evident, immutable data repository. Systems and methods provided herein explicitly use and combine relational database technology as (payload) data storage and the tamper-evident, immutable repository in one system on purpose.

What is claimed is:

1. A method of a blockchain audit-proof logging process, comprising:
a computer creating a log for selected tables in a relational database;
the computer creating trigger functions for insert, update, and delete operations for the selected tables, the computer using the trigger functions to:
calculate a difference between a previous record and a new record, calculate a cryptographic hash code for the new record, and
write the previous record to the log.

2. The method of claim 1, wherein calculation of the cryptographic hash code for the new record includes a hash code and time stamp associated with the previous record.

3. The method of claim 1, wherein the log supports proving manipulation of data input, the manipulation occurring during processes of at least one of collecting, storing, and calculating desired results based on the data input.

4. The method of claim 1, further comprising the computer generating a data history accessible in human-readable format.

5. The method of claim 4, further comprising the computer providing software to client devices that checks consistency of the data history.

6. The method of claim 5, further comprising the computer checking the consistency by recalculating cryptographic hash codes.

7. The method of claim 5, wherein the provided software comprises at least source code and binary executable software.

8. A system for implementing a blockchain audit-proof logging process, comprising:
at least one physical computer;
a relational database executing on the at least one physical computer; and
an application executing on the at least one computer that:
collects user data in multiple steps,
stores the data in the relational database after each step, and
calculates results based on previously entered data,
wherein the application, during calculation of the results, generates a cryptographic hash code of a first submitted item of user data and thereafter generates cryptographic hash codes of subsequently submitted items of user data.

9. The system of claim 8, wherein the data is stored after each step upon the client device receiving execution of at least one of a “next” and a “save” selectable object.

10. The system of claim 8, wherein the system provides downloadable software to the client device as source code and binary executables.

11. The system of claim 10, wherein the downloadable software promotes verification of correctness of data input history.

12. The system of claim 8, wherein the relational database uses event triggers to take actions after insert and update steps.

13. The system of claim 12, wherein the use of event triggers supports assurance that each insert and each update cause required actions independent of event source.

14. A system for using blockchain to support integrity of a data manipulation history, comprising:
a computer;
a database stored at least partially on the computer; and
an application executing on the computer that:
receives an initial data record from a user device,
transmits an initial cryptographic hash code of the initial data record to the user device,
provides download access to historical data records, and
promotes calculation of cryptographic hash codes of data records generated subsequent to the initial data record.

15. The system of claim 14, wherein the subsequent cryptographic hash codes contain previous cryptographic hash codes including the initial hash code and associated time stamps.

16. The method of claim 14, further comprising the computer providing software to client devices that checks consistency of the data history.

17. The method of claim 16, further comprising the client devices checking the consistency by recalculating cryptographic hash codes.

18. The method of claim 16, wherein the provided software comprises at least source code and binary executable software.

19. The system of claim 14, wherein the system uses event triggers to take actions after insert and update steps.

20. The system of claim 19, wherein the use of event triggers assures that each insert and each update cause required actions independent of event source.
